(19) United States
(12) Patent Application Publication
(10) Pub. No.: US 2026/0122359 A1
(43) Pub. Date: Apr. 30, 2026

(54) IMAGE PROCESSING APPARATUS, IMAGE PICKUP APPARATUS, IMAGE PROCESSING METHOD, AND STORAGE MEDIUM

(71) Applicant: CANON KABUSHIKI KAISHA, Tokyo (JP)

(72) Inventors: YUKI YOSHIMURA, Tokyo (JP); HIROTARO KIKUCHI, Tokyo (JP)

(21) Appl. No.: 19/318,865

(22) Filed: Sep. 4, 2025

(30) Foreign Application Priority Data
Oct. 29, 2024 (JP) 2024-189428

(51) Int. Cl. H04N 23/80; H04N 23/61; H04N 23/63; H04N 23/67; H04N 25/53; H04N 25/705

(52) U.S. Cl. CPC H04N 23/80; H04N 23/61; H04N 23/635; H04N 23/671; H04N 25/53; H04N 25/705

(57) ABSTRACT

Image processing apparatuses, image pickup apparatuses, image processing methods, and storage media are provided herein. One or more image processing apparatuses may include one or more memories storing instructions, and one or more processors that, upon execution of the instructions, operate to detect a first object and a plurality of second objects from an image, obtain information on a distance of each of the first object and the plurality of second objects, and determine an image area from the image including a first area including the first object and a second area including at least one second object selected from the plurality of second objects according to the information on the distance.

### BACKGROUND

### Field of the Technology

The aspect of the disclosure relates to one or more embodiments of an image processing apparatus, an image pickup apparatus, an image processing method, and a storage medium.

### Description of the Related Art

An autofocus (AF) function configured to calculate a focus detection amount from a signal of an object detected from an image and perform focusing has recently been demanded to simultaneously perform focus on a plurality of objects that are not to be focused. Japanese Patent No. 6253454 discloses a configuration that controls an aperture stop such that a plurality of objects are within a depth of field.

However, the configuration disclosed in Japanese Patent No. 6253454 may slow down the shutter speed or increase the ISO speed excessively for proper exposure, which may result in deterioration of image quality. The image may have the objects all of which are in focus excessively, and an object that the user intends to emphasize cannot be emphasized.

### SUMMARY

One or more embodiments of an image pickup apparatus according to one or more aspects of the disclosure may include one or more memories storing instructions, and one or more processors that, upon execution of the instructions, operate to detect a first object and a plurality of second objects from an image, obtain information on a distance of each of the first object and the plurality of second objects, and determine an image area from the image including a first area including the first object and a second area including at least one second object selected from the plurality of second objects according to the information on the distance. One or more embodiments of an image pickup apparatus may include the above one or more image processing apparatuses. One or more embodiments of an image processing method corresponding to the above one or more image processing apparatuses. A storage medium storing a program that causes a computer to execute the above one or more control methods also constitutes another aspect of the disclosure.

Features of the disclosure will become apparent from the following description of embodiments with reference to the attached drawings. The following description of embodiments is described by way of example.

### BRIEF DESCRIPTION OF THE DRAWINGS

FIG. 1 is a cross-sectional view illustrating the configuration of a digital single-lens camera as an example of an electronic apparatus according to a first embodiment.

FIG. 2 is a block diagram illustrating the electrical configuration of the camera according to the first embodiment.

FIG. 3 is a schematic diagram of a pixel array of an image sensor according to the first embodiment.

FIGS. 4A and 4B are a schematic plan view and a schematic cross-sectional view of a pixel in the first embodiment.

FIG. 5 illustrates a relationship between a cross-sectional view of a pixel structure and an exit pupil plane of an imaging optical system in the first embodiment.

FIG. 6 is a schematic diagram illustrating a correspondence between an image sensor and pupil division in the first embodiment.

FIG. 7 is a schematic diagram illustrating a relationship between a defocus amount and an image shift amount of a focus detecting signal in the first embodiment.

FIGS. 8A and 8B illustrate a relationship between an aperture stop and a base length in an imaging optical system according to the first embodiment.

FIGS. 9A and 9B illustrate a relationship between a focus-detecting image height and a base length in the first embodiment.

FIG. 10 is a flowchart illustrating an example of focus detecting processing according to the first embodiment.

FIG. 11 illustrates a schematic example of a focus detecting area according to the first embodiment.

FIG. 12 illustrates a state in which a main object and a sub-object are detected in the first embodiment.

FIG. 13 illustrates an example of a plurality of objects in the first embodiment.

FIGS. 14A and 14B illustrate the depth positions of object areas detected in FIG. 13 in the first embodiment.

FIG. 15 illustrates that object area candidates that include a plurality of object areas detected in FIG. 13 in the first embodiment are added.

FIG. 16 illustrates that object area candidates that include a plurality of object areas detected in FIG. 13 in the first embodiment are added, including a UI display of an aperture value (F-number).

FIG. 17 is a flowchart illustrating an example of depth adjustment processing in the first embodiment.

FIG. 18 is a flowchart illustrating the electrical configuration of a camera according to a second embodiment.

FIG. 19 is a flowchart illustrating an example of depth adjustment processing according to the second embodiment.

### DESCRIPTION OF THE EMBODIMENTS

In the following, the term “unit” may refer to a software context, a hardware context, or a combination of software and hardware contexts. In the software context, the term “unit” refers to a functionality, an application, a software module, a function, a routine, a set of instructions, or a program that can be executed by a programmable processor such as a microprocessor, a central processing unit (CPU), or a specially designed programmable device or controller. A memory contains instructions or programs that, when executed by the CPU, cause the CPU to perform operations corresponding to units or functions. In the hardware context, the term “unit” refers to a hardware element, a circuit, an assembly, a physical structure, a system, a module, or a subsystem. Depending on the specific embodiment, the term “unit” may include mechanical, optical, or electrical components, or any combination of them. The term “unit” may include active (e.g., transistors) or passive (e.g., capacitor) components. The term “unit” may include semiconductor devices having a substrate and other layers of materials having various concentrations of conductivity. It may include a CPU or a programmable processor that can execute a program stored in a memory to perform specified functions. The term “unit” may include logic elements (e.g., AND, OR) implemented by transistor circuits or any other switching circuits. In the combination of software and hardware contexts, the term “unit” or “circuit” refers to any combination of the software and hardware contexts as described above. In addition, the term “element,” “assembly,” “component,” or “device” may also refer to “circuit” with or without integration with packaging materials.

### First Embodiment

Referring now to the accompanying drawings, a detailed description will be given of embodiments according to the disclosure. Corresponding elements in respective figures will be designated by the same reference numerals, and a duplicate description thereof will be omitted.

### Overall Configuration

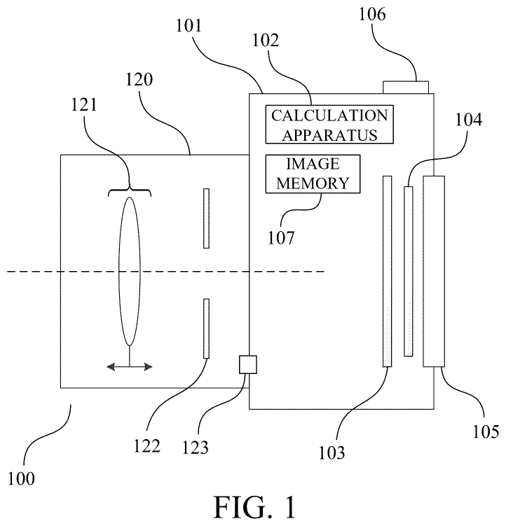

FIG. 1 is a cross-sectional view illustrating the configuration of a digital single-lens camera (also simply referred to as a camera hereinafter) 100 as an example of an electronic apparatus according to this embodiment. In this embodiment, the electronic apparatus is a digital camera (image pickup apparatus) as an example, but the disclosure is not limited to this example.

The camera 100 includes a camera body (image pickup apparatus) 101 and a lens unit (lens apparatus) 120 attachable to and detachable from the front-side part (object-side part) of the camera body 101. The lens unit 120 includes a focus lens 121 and an aperture stop (diaphragm) 122, etc., and is electrically connected to the camera body 101 via a mount contact portion 123. Thereby, a light amount taken into the camera body 101 and a focus position can be adjusted. The focus lens 121 can also be adjusted manually by the user.

An image sensor 104 includes a CCD sensor, a CMOS sensor, etc., and includes an infrared cut filter and a low-pass filter, etc. In capturing an image, the image sensor 104 photoelectrically converts an object image formed by passing through the imaging optical system of the lens unit 120, and transmits a signal for generating a captured image to a calculation apparatus 102. The calculation apparatus 102 generates the captured image from the received signal, stores the image in the image memory 107, and displays it on the display unit 105, such as an LCD. A shutter 103 blocks light from the image sensor 104 during non-imaging, and opens to expose the image sensor 104 to light during imaging.

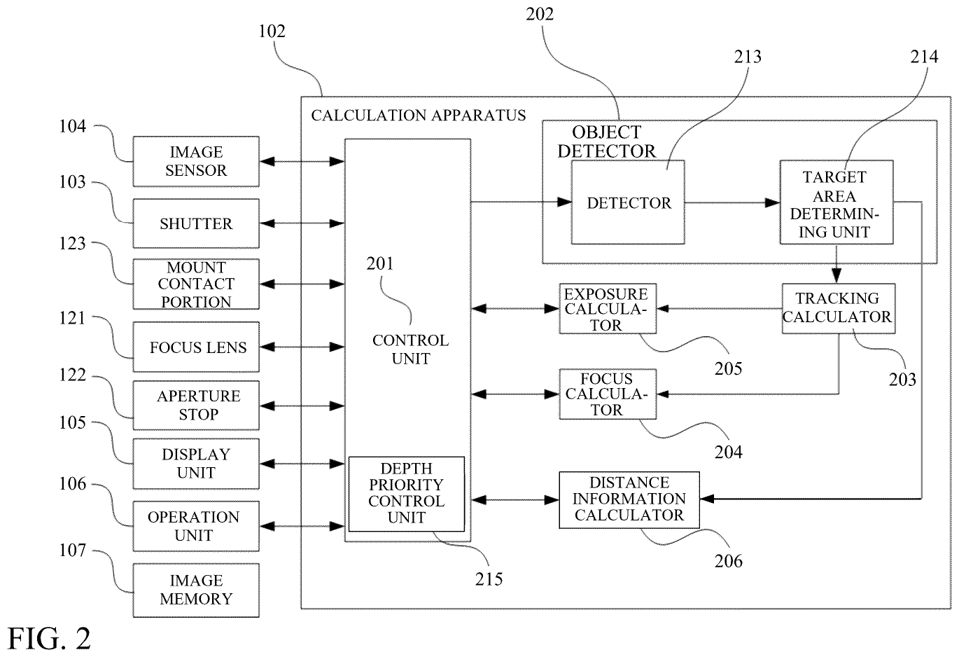

FIG. 2 is a block diagram illustrating the electrical configuration of the camera 100. The calculation apparatus 102 is an image processing apparatus that includes a multi-core CPU that can process multiple tasks in parallel, RAM, and ROM, as well as dedicated circuits for executing specific calculation processing at a high speed. Due to these hardware components, the calculation apparatus 102 includes a control unit 201, an object detector 202, a tracking calculator 203, a focus calculator 204, and an exposure calculator (setting unit) 205. The control unit 201 controls each part of the camera body 101 and the lens unit 120.

The object detector 202 includes a detector 213, and a target-area determining unit (selector) 214. The detector 213 detects a specific area from an image (such as overall identification of people, animals, insects, plants, vehicles, etc., or more specifically, face and pupils (eyes) in the case of people, animals, and insects; flowers, branches, leaves in the case of plants; and partial identification of the front part and passengers in the case of vehicles). There are cases where no specific areas are detected, and cases where a plurality of specific areas are detected. A detector for the pupils of people and animals is included in the detector 213. The detection method may use an known arbitrary method such as AdaBoost or a convolutional neural network. The implementation form may be a program running on a CPU, dedicated hardware, or a combination of them.

The object detection result obtained from the detector 213 is sent to the target-area determining unit 214, which selects one or more objects such as a person and object parts such as pupils that have been detected, and determines them as target areas to be used for depth priority control, which will be described later. The target area is determined using a known calculation method based on the type, size, and position of the detected object and object part, and the like. In addition to objects such as people and object parts such as eyes detected by the detector 213, the target area may be determined based on the past detection result, a feature amount such as an edge of the target frame, defocus information about an object, and the like. The target-area determining unit 214 determines the priority of each target area, prioritizes the priority object (referred to as a main object or a first object hereinafter) and the secondary object (second object), and groups the first and second groups using information on a distance. For the main object and secondary object, a representative area may be set for a single object to set the target area as a single area, or a plurality of target areas may be set for a single object. Information on a distance refers to general information that indicates the position (distance) of an object in the depth direction in an image, and may be information in an absolute coordinate system (such as distance information from the camera that performs imaging) or information in a relative coordinate system (such as a defocus amount from a focus position during imaging).

The tracking calculator 203 performs tracking processing for the target area based on the detection information on the target area determined by the target-area determining unit 214. The tracking method may be a known method such as template matching that compares features between frames.

The focus calculator 204 acquires defocus information for focusing and calculates a control value for the focus lens 121.

The exposure calculator 205 calculates a control value for the aperture stop 122, image sensor 104, shutter 103, etc., for properly exposing a main object area. Here, a specific example of the calculation of the control value will be given. In a case where the aperture stop 122 is controlled to a smaller value, an amplification amount (gain amount) of the signal for generating the image obtained by the image sensor 104 is reduced in order to properly control the exposure, and the time that the shutter 103 is open is reduced (the shutter speed is increased). In a case where the aperture stop 122 is controlled to a larger value, the gain amount is increased in order to properly control the exposure, and the shutter speed is reduced.

The distance information calculator (acquiring unit) 206 acquires defocus information for the object detected by the target-area determining unit 214, and calculates distance information corresponding to the distance in the depth direction from the camera 100 to the object. A position of an object in the depth direction obtained based on the calculated distance information will be referred to as a “depth position,” and a depth difference in the depth direction between a plurality of objects will be referred to as a “depth difference.” This embodiment calculates the distance information using the difference in defocus amount calculated by the phase-difference detecting method, but the disclosure is not limited to this example. The distance information may be acquired using an optical sensor such as LiDAR that obtains distance information using reflection of laser light, an acoustic sensor that obtains distance information using sound reflection, and a parallax amount calculated from a plurality of images with parallax (such as a camera serving as an optical sensor). The distance information may be obtained using any known method.

The control unit 201 controls the focus lens 121, the aperture stop 122, the display unit 105, etc. based on the results of the object detector 202, the exposure calculator 205, and the focus calculator 204. The control unit 201 includes a depth-priority control unit 215. In a case where a plurality of target areas are set by the object detector 202 (in a case where depth priority imaging is set), the depth-priority control unit 215 determines whether it is possible to accommodate a plurality of target areas within a specific depth, using the distance information from the distance information calculator 206. In a case where the depth-priority control unit 215 determines that it is possible to accommodate the plurality of target areas within the specific depth, it calculates control values for the focus lens 121 and the aperture stop 122. The focus lens 121 and the aperture stop 122 are controlled based on the calculated control values. In response to the control result, the display unit 105 performs frame display on the display screen indicating whether the object is in focus or out of focus. Here, the specific depth generally refers to the depth of field, but may be any depth that is set arbitrarily. In addition, an object that falls within the specific depth will be defined as being in focus.

The operation unit 106 includes a release switch, a mode dial, and the like, and the control unit 201 can receive an imaging instruction, a mode change instruction, and the like from the user through the operation unit 106. The above is the configuration of the camera 100 according to this embodiment.

### Image Sensor

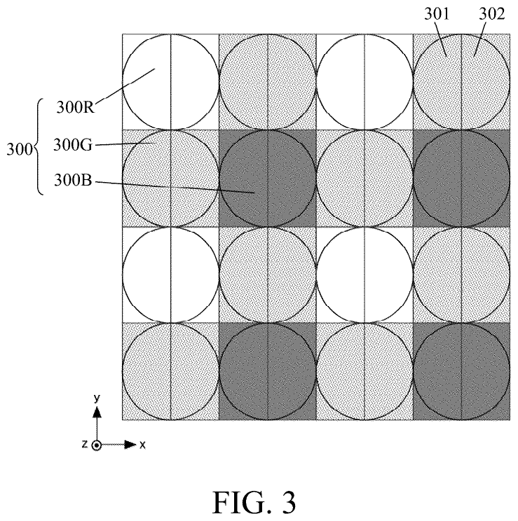

FIG. 3 is a schematic diagram of a pixel array on the image sensor (two-dimensional CMOS sensor) 104 according to this embodiment, and illustrates the imaging pixel array in a range of 4 columns×4 rows and the focus detecting pixel array in a range of 8 columns×4 rows. In this embodiment, in the 2 columns×2 rows pixel group 300, a pixel 300R having a spectral sensitivity of R (red) is disposed at the top left, a pixel 300G having a spectral sensitivity of G (green) is disposed at the top right and bottom left, and a pixel 300B having a spectral sensitivity of B (blue) is disposed at the bottom right. Each pixel includes a first focus detecting pixel 301 and a second focus detecting pixel 302 arranged in 2 columns×1 row. A large number of the 4 columns×4 rows pixels (8 columns×4 rows of focus detecting pixels) in FIG. 3 are arranged on a surface, and a captured image (focus detecting signal) can be acquired.

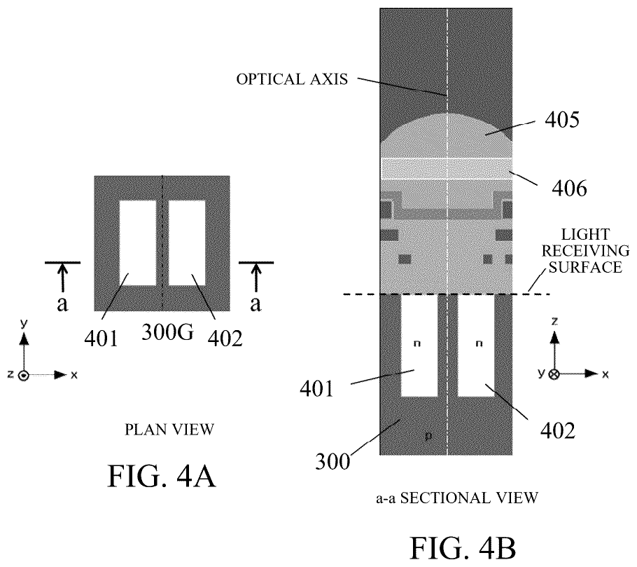

FIG. 4A illustrates a plan view of pixel 300G when viewed from the light receiving surface side (+z side) of image sensor 104, and FIG. 4B illustrates a cross-sectional view of the a-a cross section of FIG. 4A when viewed from the −y side.

As illustrated in FIGS. 4A and 4B, in pixel 300G, a microlens 405 for condensing incident light is formed on the light receiving surface side, and a photoelectric converter 401 and a photoelectric converter 402 are formed that are NH divided (divided into two) in the x direction and Ny divided (divided into one) in the y direction. The photoelectric converters 401 and 402 correspond to the first focus detecting pixel 301 and the second focus detecting pixel 302, respectively.

The photoelectric converters 401 and 402 may be pin structure photodiodes with an intrinsic layer sandwiched between a p-type layer and an n-type layer, or may be pn junction photodiodes by omitting the intrinsic layer, as necessary.

In each pixel, a color filter 406 is formed between a microlens 405 and the photoelectric converters 401 and 402. In this embodiment, a color filter having a spectral sensitivity of R (red), a color filter having a spectral sensitivity of G (green), or a color filter having a spectral sensitivity of B (blue) is disposed. However, the spectral sensitivity characteristics of the color filter are not limited to RGB, or the color filter may be omitted.

In FIGS. 4A and 4B, light incident on the pixel 300G is condensed by the microlens 405, dispersed by the color filter 406, and then received by the photoelectric converters 401 and 402. In the photoelectric converters 401 and 402, pairs of electrons and holes are generated according to a received light amount, and after separation by the depletion layer, the negatively charged electrons are accumulated in the n-type layer (not illustrated), and the holes are discharged to the outside of the image sensor through the p-type layer connected to a constant voltage source (not illustrated).

Electrons accumulated in the n-type layers (not illustrated) of the photoelectric converters 401 and 402 are transferred to the capacitance unit (FD) via a transfer gate and converted into a voltage signal.

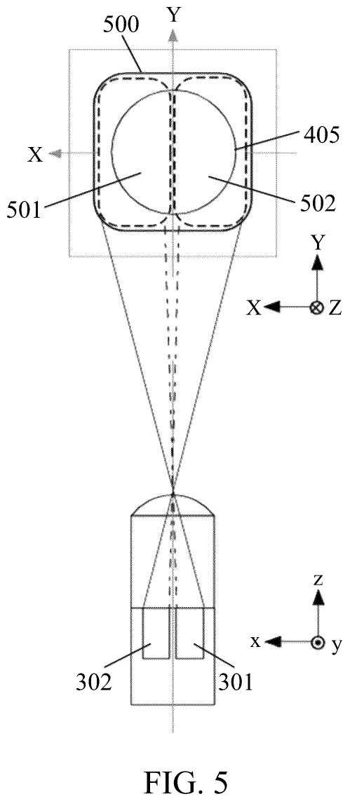

FIG. 5 is a cross-sectional view of the a-a section in FIG. 4A viewed from the +y side, and illustrates a relationship with the exit pupil plane of the imaging optical system. In FIG. 5, the x-axis and y-axis of the cross-sectional view are inverted compared to FIGS. 4A and 4B in order to correspond to the coordinate axes of the exit pupil plane.

A first partial pupil region 501 of the first focus detecting pixel 301 is in a roughly conjugate relationship with the light receiving surface of the photoelectric converter 401, the center of gravity of which is decentered in the −x direction, due to the microlens, and represents a pupil region that can receive light by the first focus detecting pixel 301. The first partial pupil region 501 of the first focus detecting pixel 301 has its center of gravity decentered on the +x side on the pupil plane.

A second partial pupil region 502 of the second focus detecting pixel 302 is in a roughly conjugate relationship with the light receiving surface of the photoelectric converter 402, whose center of gravity is decentered in the +x direction, due to the microlens, and represents a pupil region that can receive light by the second focus detecting pixel 302. The second partial pupil region 502 of the second focus detecting pixel 302 has its center of gravity decentered on the −x side of the pupil plane.

The pupil region 500 is a pupil region that can receive light in the entire pixel 300G in a case where the photoelectric converters 401 and 402 (first focus detecting pixel 301 and second focus detecting pixel 302) are combined.

In the image-plane phase-difference AF, the pupil is divided using the microlens 405, so it is affected by diffraction. In FIG. 5, the pupil distance to the exit pupil plane is several tens of mm, while the diameter of the microlens 405 is several μm. Therefore, the aperture value of the microlens 405 is several tens of thousands, and diffraction blurring on the level of several tens of mm occurs. Therefore, the image of the light receiving surface of the photoelectric converter is not a clear pupil region or partial pupil region, but a pupil intensity distribution (incident angle distribution of light receiving rate).

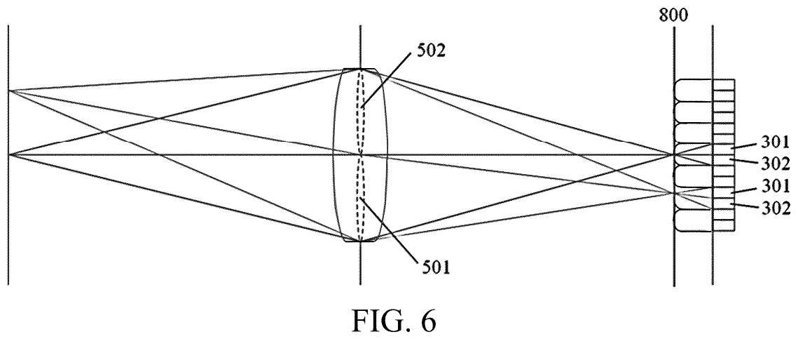

FIG. 6 is a schematic diagram illustrating the correspondence between the image sensor 104 and pupil division. The light beams that pass through the different partial pupil regions of the first partial pupil region 501 and the second partial pupil region 502 are incident on each pixel of the image sensor 104 at different angles and are received by the first focus detecting pixel 301 and the second focus detecting pixel 302, which are divided into 2×1 regions. In this embodiment, the pupil region is divided into two in the horizontal direction, but the pupil may also be divided in the vertical direction, as necessary.

In this embodiment, a first focus detecting pixel that receives a light beam that passes through the first partial pupil region, a second focus detecting pixel that receives a light beam that passes through the second partial pupil region, and an imaging pixel that receives a light beam that passes through a pupil region consisting of the first and second partial pupil regions are arranged in a plurality of arrays. In this embodiment, each imaging pixel includes the first focus detecting pixel 301 and the second focus detecting pixel 302. If necessary, the imaging pixel and the first and second focus detecting pixels may be configured as separate pixels, and the first focus detecting pixel and the second focus detecting pixel may be partially arranged in a part of the imaging pixel array.

In this embodiment, the light receiving signals from the first focus detecting pixel 301 are collected to generate a first focus detecting signal, and the light receiving signals from the second focus detecting pixel 302 are collected to generate a second focus detecting signal, and focus detection is performed.

### Relationship Between Defocus Amount and Image Shift Amount

A description will now be given of a relationship between a defocus amount and an image shift amount of the first focus detecting signal and the second focus detecting signal acquired by the image sensor 104.

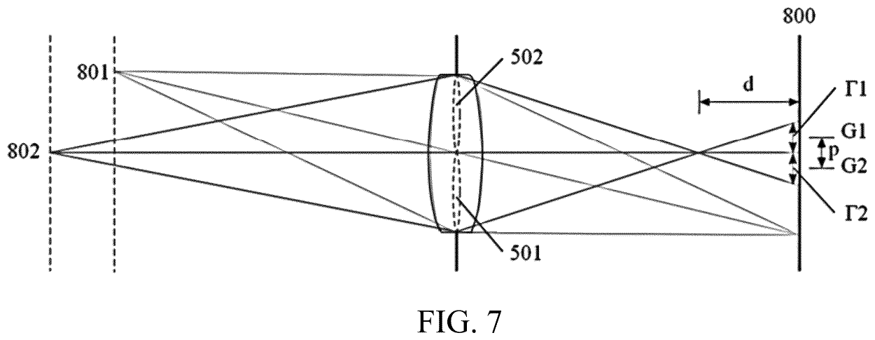

FIG. 7 is a schematic diagram of the relationship between the defocus amount of the first focus detecting signal and the second focus detecting signal, and the image shift amount between the first focus detecting signal and the second focus detecting signal. The image sensor (not illustrated) 104 is placed on an imaging surface 800, and an exit pupil of the imaging optical system is divided into the first partial pupil region 501 and the second partial pupil region 502.

A defocus amount d is defined as a distance from an imaging position of an object to the imaging surface as magnitude |d|, a front focus state in which the imaging position of the object is located on the object side of the imaging surface as negative sign (d<0), and a rear focus state in which the imaging position of the object is located on the opposite side of the object from the imaging surface as positive sign (d>0). An in-focus state in which the imaging position of the object is located on the imaging surface (in-focus position) corresponds to d=0. An object 801 illustrates an example of an in-focus state (d=0), and an object 802 illustrates an example of a front focus state (d<0). The front focus state (d<0) and the rear focus state (d>0) are combined to form a defocus state (|d|>0).

In the front focus state (d<0), the light beam from the object 802 that passes through the first partial pupil region 501 (second partial pupil region 502) is first condensed, and then spreads to a width Γ1 (Γ2) centered on the center of gravity G1 (G2) of the light beam, forming a blurred image on the imaging surface 800. The blurred image is received by the first focus detecting pixel 301 (second focus detecting pixel 302) that constitutes each pixel disposed on the image sensor, and the first focus detecting signal (second focus detecting signal) is generated. Thus, the first focus detecting signal (second focus detecting signal) is recorded at the center of gravity G1 (G2) on the imaging surface 800 as an object image in which the object 802 is blurred to a width Γ1 (Γ2). The blur width Γ1 (Γ2) of the object image increases roughly in proportion to the increase in the magnitude |d| of the defocus amount d. Similarly, the magnitude |p| of the image shift amount p (=a difference G1-G2 between the center of gravity positions of the light beams) of the object image between the first focus detecting signal and the second focus detecting signal also increases roughly in proportion to the increase in the magnitude |d| of the defocus amount d. This is similarly applicable to the rear focus state (d>0), although the image shift direction of the object image between the first focus detecting signal and the second focus detecting signal is opposite to that in the front focus state.

Thus, the defocus amount d can be calculated from the conversion coefficient K for converting the image shift amount p to the defocus amount d, which has been calculated in advance, and the image shift amount p of the object image between the first focus detecting signal and the second focus detecting signal. The image shift amount can be converted into the defocus amount using the following equation (1):

$$p = d \times K \qquad ( 1 )$$

In this embodiment, as the defocus amount of the first focus detecting signal and the second focus detecting signal, or the image signal obtained by adding the first and second focus detecting signals, increases, the image shift amount between the first focus detecting signal and the second focus detecting signal increases.

This embodiment performs focusing using the phase-difference detecting method and the relationship between the defocus amount and the image shift amount of the first focus detecting signal and the second focus detecting signal. The focusing using the phase-difference detecting method shifts the first focus detecting signal and the second focus detecting signal relative to each other, calculates a correlation amount that represents the degree of coincidence of the signals, and detects an image shift amount from the shift amount that improves the correlation (degree of coincidence of the signals). Based on the relationship in which the image shift amount between the first focus detecting signal and the second focus detecting signal increases as the defocus amount of the image signal increases, focus detection using the phase-difference detecting method is performed by converting the image shift amount into a defocus amount.

### Base Length

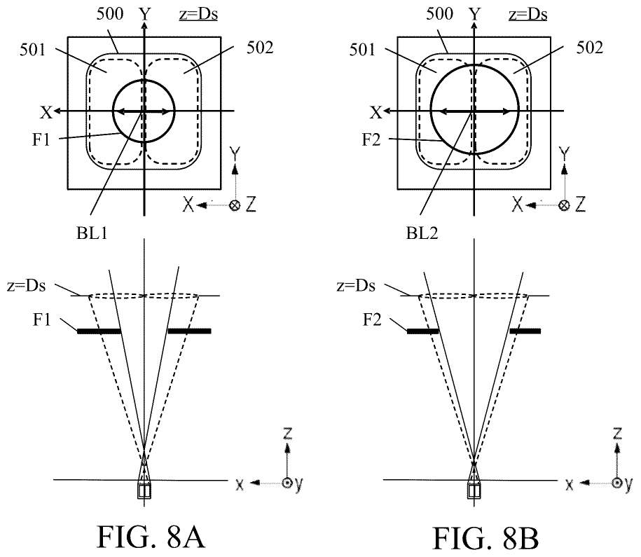

A relationship between the aperture stop in the imaging optical system and the base length will be described with reference to FIGS. 8A and 8B. In this embodiment, a distance from the surface of the image sensor to the position where the principal ray of each pixel on the image sensor intersects is defined as a pupil distance of the image sensor. z=Ds indicates the pupil distance of the image sensor. F1 and F2 indicate an aperture size at each aperture value F. FIG. 8A illustrates a light shielding state of a light beam by the imaging optical system with an aperture value of F1, and a base length is BL1. FIG. 8B illustrates a light shielding state of a light beam by the imaging optical system with an aperture value of F2, which is brighter than F1, and a base length is BL2. At the same image height, the darker the aperture value is, the more the incident light beam is restricted, and the base length BL1 is shorter than the base length BL2.

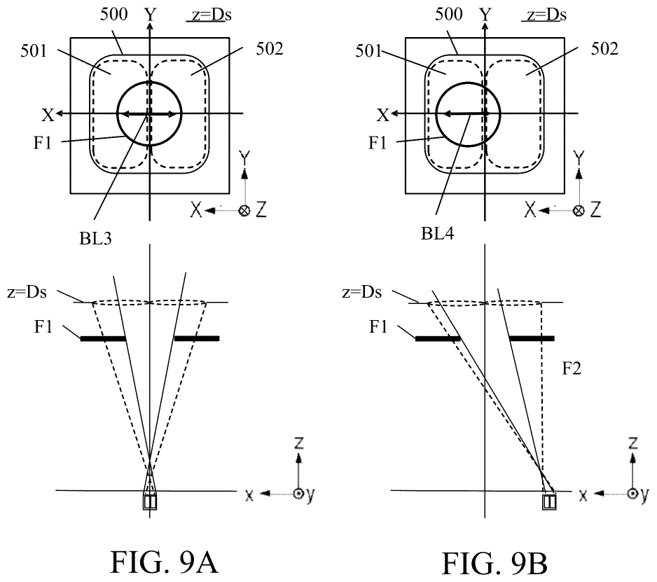

A relationship between the focus-detecting image height and base length will be described with reference to FIGS. 9A and 9B. FIG. 9A illustrates a light shielding state of a light beam by the imaging optical system in a case where the focus detecting area including the image height coordinates is set to the central image height ((x_{AF}, y_{AF})=(0, 0)). For the central image height in FIG. 9A, the base length is BL3. FIG. 9B illustrates a light shielding state of a light beam by the imaging optical system in a case where the focus detecting area is set to the peripheral image height ((x_{AF}, y_{AF})=(−10, 0)). For the peripheral image height in FIG. 9B, the base length is BL4. For the same aperture value, the base length is reduced as the focus detecting position moves from the central image height to the periphery, and base length BL4 is shorter than base length BL3.

The base length BL for the pupil distance Ds of the image sensor is proportional to the image shift amount p for the defocus amount d. Therefore, the relationship between the base length and the conversion coefficient K from the image shift amount to the defocus amount can be expressed as in the following equation (2), and the darker the aperture value is or the farther the focus-detecting image height is from the central image height (=the shorter the base length is), the larger the conversion coefficient is from the image shift amount to the defocus amount:

$$Ds / BL ∼ d / p = K \qquad ( 2 )$$

### Example of Focus Detecting Processing

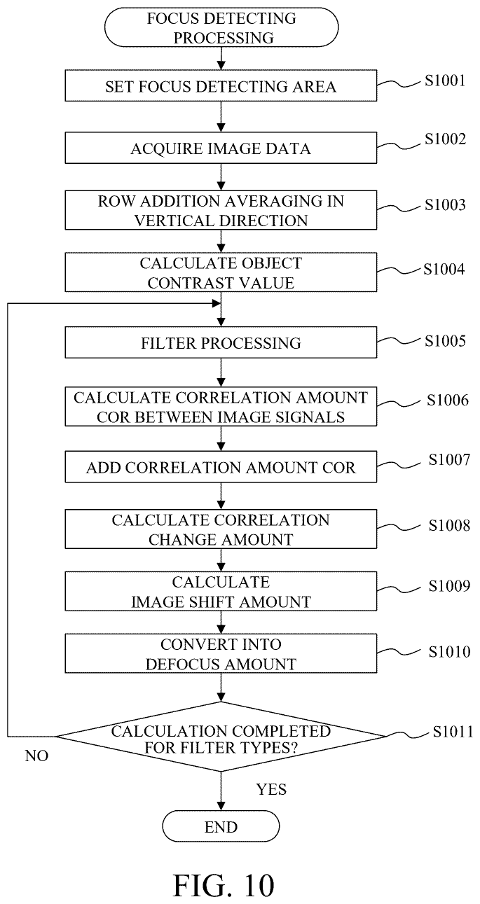

The focus detecting processing will be explained below. FIG. 10 is a flowchart illustrating an example of focus detecting processing.

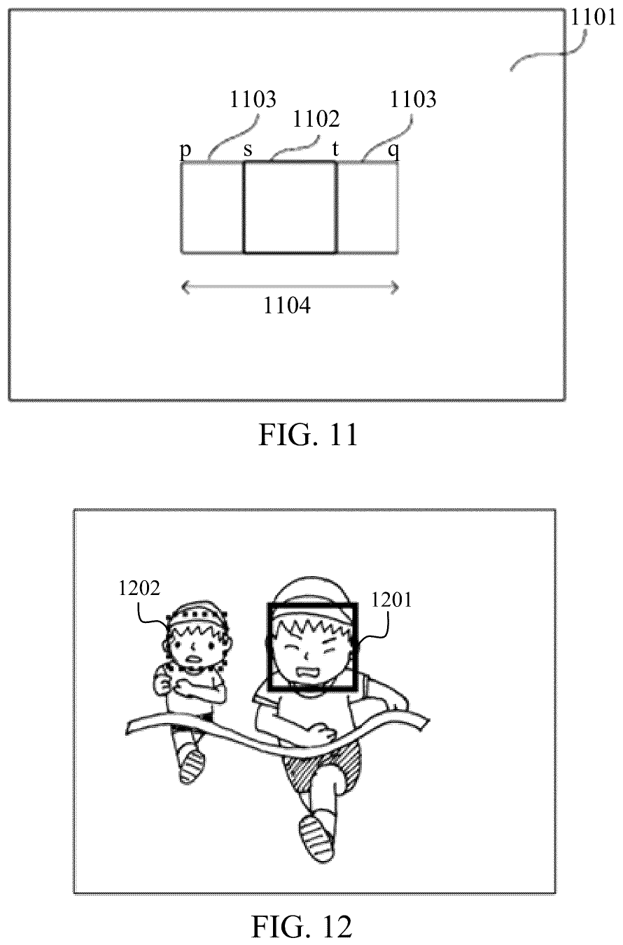

FIG. 11 is a schematic diagram illustrating an example of a focus detecting area 1102. Shift areas 1103 on both sides of the focus detecting area 1102 are areas for correlation calculation. Therefore, a pixel area 1104, which is a combination of the focus detecting area 1102 and the shift areas 1103, is the pixel area for correlation calculation. In FIG. 11, each of p, q, s, and t represents coordinates in the horizontal direction (x-axis direction), with p and q respectively indicating the x-coordinates of the start and end points of the pixel area 1104, and s and t respectively indicating the x-coordinates of the start and end points of the focus detecting area 1102.

In step S1001, the focus calculator 204 sets a focus detecting area 1102 in an arbitrary range from the focus detecting areas 1102 arranged two-dimensionally within the imaging screen (see FIG. 11).

In step S1002, the focus calculator 204 acquires image data to acquire a pair (two) image signals (images A and B) for focus detection from the image sensor 104 for the set focus detecting area 1102.

In step S1003, the focus calculator 204 performs row averaging in the vertical direction for the acquired pair of image signals to reduce the noise influence. Here, the vertical direction refers to the extension direction of the vertical signal line (vertical transmission path) of the image sensor 104. In this embodiment, in a case where high-speed calculation processing is required, such as in a continuous shooting mode, the number of vertical row additions is reduced, and in scenes where signal noise is noticeable, such as in dark places, the number of vertical row additions is increased.

In step S1004, the focus calculator 204 calculates an object contrast value to calculate an object contrast value CNT defined by the following equation (3):

$$CNT = ( Peak - Bottom ) / Peak \qquad ( 3 )$$

where Peak is a variable indicating the maximum value (maximum output value) of the waveform averaged in the vertical direction, and Bottom is a variable indicating the minimum value (minimum output value) of the waveform averaged in the vertical direction.

As illustrated in equation (1), the focus calculator 204 calculates the object contrast value CNT by dividing the difference between the maximum and minimum values of the waveform averaged in the vertical direction by the maximum value. The object contrast value CNT is used to evaluate the reliability of the defocus amount.

In step S1005, the focus calculator 204 performs filter processing to extract a signal component of a predetermined frequency band from the signal obtained by performing row averaging in the vertical direction in step S1003. This embodiment previously prepares three types of filters (low-frequency band filter, mid-frequency band filter, and high-frequency band filter) that extract different frequency bands. Then, which defocus amount is used among the defocus amounts calculated using each filter is switched according to the blur degree of the object and the like. In a case where a low-frequency band filter is used, the distance measurement performance (defocus amount calculation performance) is improved for a highly blurred object whose edge is broken. In a case where a high-frequency band filter is used, the distance can be measured with high accuracy near the focal point where the edge of the object is sharp (the accuracy of the defocus amount calculation can be improved). The configuration is not limited to three types of filters as long as at least one type of filter is used.

In step S1006, the focus calculator 204 calculates a correlation amount COR between a pair (two) of acquired image signals (i.e., signal components of a predetermined frequency band extracted by filter processing). In this embodiment, this calculation will be referred to as “correlation calculation.” The focus calculator 204 performs the correlation calculation for each scanning line after vertical averaging in the focus detecting area.

In step S1007, the focus calculator 204 adds the waveforms of the correlation amount COR in the focus detecting area.

In step S1008, the focus calculator 204 calculates a correlation change amount from the correlation amount COR.

In step S1009, the focus calculator 204 calculates a shift amount (image shift amount) between the two images (images A and B) based on the calculated correlation change amount.

In step S1010, the focus calculator 204 calculates a defocus amount by multiplying the shift amount between the two images calculated in step S1009 by a predetermined conversion coefficient. The conversion coefficient that is used at this time is determined by the aperture value, the lens exit pupil distance, individual information on the image sensor 104, and the coordinates for setting the focus detecting area 1102, and is stored in advance in a ROM (not illustrated). The focus calculator 204 then divides the calculated defocus amount by the aperture value and the permissible circle of confusion diameter δ for normalization. Thereby, a defocus amount can be evaluated with the same index even if the aperture value is different.

In step S1011, the focus calculator 204 determines whether the processing of steps S1005 to S1010 has been performed for all three types of filters (low-frequency band filter, mid-frequency band filter, and high-frequency band filter) that have been prepared in advance. In a case where there are any filters that have not yet been performed (in the case of no “N”), the flow returns to step S1005, and the processing of steps S1005 to S1010 is performed for the filter that has not yet been performed. In a case where the processing has been performed for all types of filters (in the case of yes “Y”), this flow ends.

### Depth Adjustment

A description will be given of a method of controlling depth by controlling the focus lens 121 and the aperture stop 122 so that a plurality of detected objects or parts of the plurality of objects are within the same depth. FIG. 12 illustrates that a main object 1201 and a secondary object 1202 are detected. First, a defocus amount is obtained as information on the depth position of each object. In FIG. 12, a defocus amount Def1 of the main object 1201 and a defocus amount Def2 of the secondary object 1202 are obtained using the method described using FIG. 10.

Next, a defocus amount difference is calculated as a depth difference between the objects, and an aperture value F is calculated so that the depth difference falls within a predetermined depth range. This embodiment sets, for example, ±Fδ, which is the product of the aperture value F and the permissible circle of confusion diameter δ, and considers a value within this predetermined depth range to be within the depth of field range. In this case, an aperture value F can be calculated to keep the main and secondary objects within the range of ±1Fδ so as to satisfy the following equation (4):

$$\vert Def 1 - Def 2 \vert = 1 F δ \qquad ( 4 )$$

This embodiment illustrates two objects as an example, but the number of objects is not limited. For three or more objects, the aperture value F may be determined so that the objects with the maximum and minimum defocus amounts are located within the same depth.

This embodiment calculates the depth position and depth range using the defocus amount, but the depth difference and depth range between objects are distance information. Therefore, distance can also be obtained using a method other than the defocus amount described above (distance acquisition using parallax information between a plurality of images with parallax, distance acquisition using active distance measurement by receiving reflected light such as Lidar, distance acquisition using sound reflection, etc.).

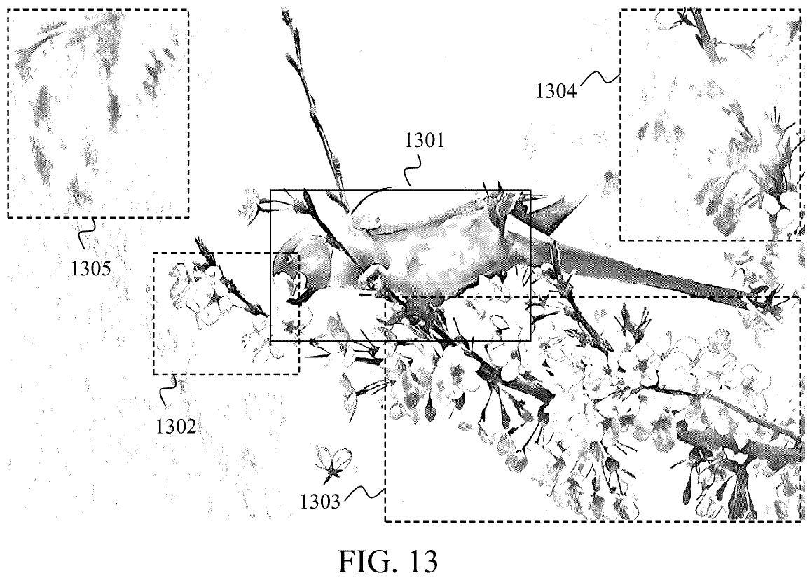

FIG. 13 illustrates an example of a plurality of objects, in which an image of a bird perched on a tree and a plurality of flowers are imaged with different defocus states. Reference numeral 1301 denotes a bird region in the object detection result, and reference numerals 1302 to 1305 denote flower regions imaged in different defocus states in the object detection result.

In a case where the number of detected objects is small as in FIG. 12, the aperture value F may be determined so that the objects with the maximum and minimum defocus amounts of the detected objects are within the same depth. However, in a case where the number of objects is large as in FIG. 13, the depth of field may be highly likely too deep, contrary to the user's intention.

In a case where the depth of field of an image is deep, the aperture value F is large, so it is necessary to slow down the shutter speed or increase the ISO speed to properly expose the image. One drawback of slowing down the shutter speed is that the influence of object blur increases and thus object blur increases for a moving object. Another drawback of increasing the ISO speed is that the image may become noisy in an imaging environment where the brightness of objects is low and a high ISO setting is required, such as indoor imaging.

Therefore, in a case where there are many objects, it is necessary to adjust the depth range by limiting it to the objects that the user intends to include in the depth of field.

### Grouping Based on Main Object Information and Distance Information

Some methods for selecting a main object from an image are known, such as a method for selecting from the object's position, a method for selecting from the object distance, and a method for selecting a high-priority object using data previously trained according to the imaging mode. This embodiment can use any method for selecting a main object from an image, and thus a description of the method for selecting the main object will be omitted.

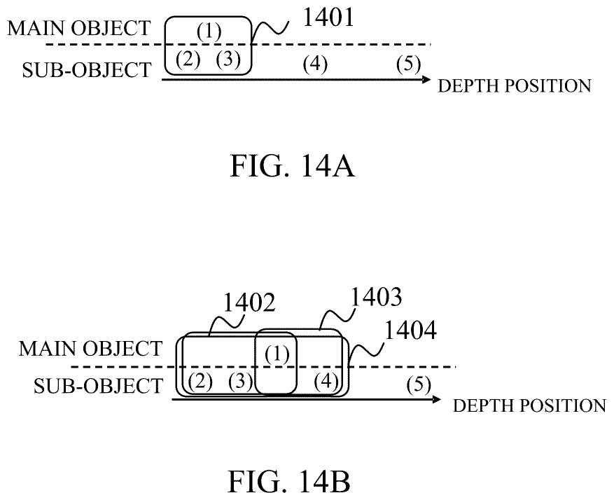

Referring now to FIG. 13, a description will be given of a composition to be imaged in which a bird is selected as the main object and a flower near the bird as the main object is selected as a secondary object. There is an imaging method that emphasizes the main object by setting an imaging condition such that a secondary object (an object detected other than the main object) that is close to the bird as the main object in depth position (defocus distance) is included in the depth of field, and other secondary objects are not included in the depth of field. In a case where this imaging method is used to image an object in the depth-priority imaging setting described above (an imaging mode setting that prioritizes imaging by including a plurality of objects in the depth of field), the aperture value is set to include all the flowers in the depth of field because the secondary objects are all flowers and are the same object. Although the user intends to easily perform imaging in focus only on the main object bird and the flower on which the bird is perched by setting the depth-priority imaging setting, other flowers may also be in focus. The imaging condition such as an excessively slow shutter speed and an excessively high ISO speed, results in problems such as the user being unable to perform imaging according to his intention. In order to solve this problem, secondary objects whose depth positions are close to the main object may be grouped and the depth may be adjusted so that the depth range of the grouped objects is included in the depth of field. This grouping method will be described with reference to FIGS. 14A and 14B.

FIGS. 14A and 14B illustrate the depth positions of the object areas 1301 to 1305 detected in FIG. 13. The depth positions of the object areas 1301, 1302, 1303, 1304, and 1305 are indicated by (1), (2), (3), (4), and (5), respectively. Reference numeral 1401 denotes a group of depth positions to be included in the depth of field in the depth adjustment in FIG. 14A. Reference numerals 1402, 1403, and 1403 respectively denote groups that are candidate groups of depth positions to be included in the depth of field in the depth adjustment in FIG. 14B.

A description will now be given of the depth positions (1) to (5) of the object areas 1301 to 1305 using the case in FIG. 14A. FIG. 14A illustrates that a depth difference between the depth positions (2) and (3) of the sub-object is small, and each of the depth positions (3) and (4) and the depth positions (4) and (5) has a depth difference. A grouping method is based on the depth position in which in a case where a depth difference between the objects exceeds a predetermined threshold value, the objects are divided into different groups. In a case where the depth difference between the depth positions (3) and (4) and the depth positions (4) and (5) exceeds a predetermined threshold value, the objects can be divided into four groups, i.e., a group of (1), a group of (2) and (3), a group of (4), and a group of (5), in FIG. 14A. The number of groups may not be plural.

In this embodiment, the depth position of the main object is processed using one representative value, but there is also a method of recognizing the main object by dividing a single object into elements and detecting it. Accordingly, since the main object may have both a single depth position and a plurality of depth positions, it is defined as a main object group (first group). Of the four groups described above, the group of sub-objects (second group) that has a small depth difference (close distance) from the main object group is a group that includes the depth positions (2) and (3). Therefore, in the depth position arrangement as illustrated in FIG. 14A, the group of depth positions to be included in the depth of field is 1401, which includes the first group and the second group.

It is conceivable that calculation methods for grouping include a method of sorting the depth positions in value order and then calculating and evaluating a depth difference at each depth position, a classifying method by the depth difference from the main object, and a method of classifying a histogram of depth positions using training data that has been previously trained. In this embodiment, for description convenience, the secondary objects (2) to (5) are divided into three groups, but they may also be classified into two groups: those with a small depth difference from the main object and those with a large depth difference from the main object.

Methods of grouping without using training data, such as a method of sorting depth positions in value order and then calculating and evaluating a depth difference at each depth position, or a classifying method by the depth difference from the main object, have a small computational scale and can be used for high-speed processing and a reduced processing circuit scale. In adopting a method that does not use training data, if there is a large amount of data, it becomes difficult to recognize the boundaries between groups. Thus, the grouping accuracy is likely to be improved by calculating the depth difference between objects using a representative depth position of each object (basically, it is better to narrow it down to one datum, but in a case where the object is large and cannot be narrowed down to one datum, it is possible to divide the same object and manage each divided area as one datum). However, this method uses a simple grouping method, and thus in a case where there are a plurality of groups and the histogram of depth positions illustrates some overlapping areas, they will be determined as the same group. In order to improve the grouping accuracy even for multiple groups, it is also necessary to use the cumulative frequency of the histogram separately for grouping.

The grouping method using training data is highly likely to successfully detect the boundaries between groups even in complex cases where there are a large number of objects, if sufficient training data is available. Therefore, in a case where the scale of calculations is to be reduced, training data may be used that has been trained using a neural network or the like by limiting input data to depth positions. In order to manage more complex object conditions, training data may be prepared that has been trained with information other than depth positions (type of object (human/animal/insect/plant/vehicle, etc.), positional relationship with the main object, and shape information on the object (shape/size/orientation, etc.)). However, in this method, the grouping accuracy of the training data depends on the number of training data, so it is necessary to prepare a large amount of training data to achieve highly accurate grouping.

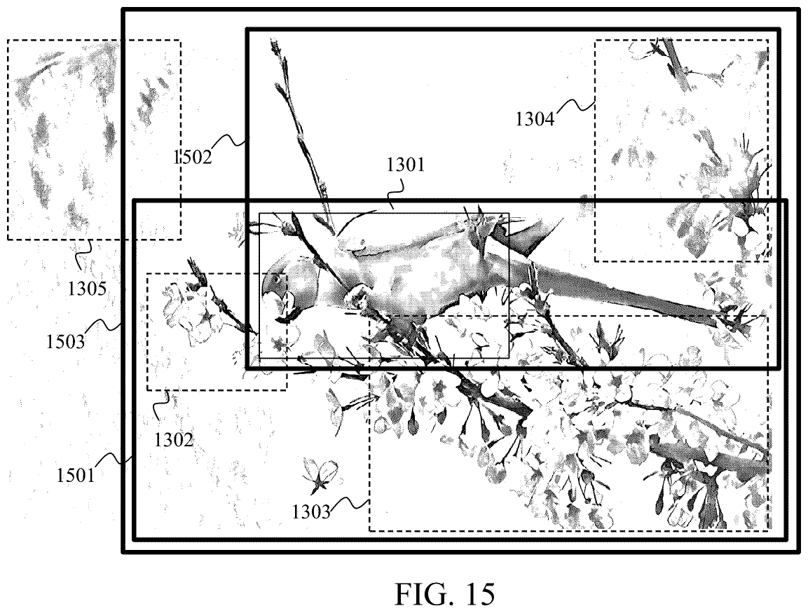

A description will now be given of the depth positions (1) to (5) of the object areas 1301 to 1305 using the case of FIG. 14B. In FIG. 14B, the depth positions other than the depth position (1) in FIG. 14A are the same, and the depth position (1) is located in the middle of the depth positions (3) and (4). In FIG. 14B, it is difficult to determine whether the second group is to be the group 1402 including (2) and (3), the group 1403 including (4), or the group 1404 including (2), (3), and (4). In such a case where the determination is difficult, a selection rule may be determined in advance, or a UI may be displayed to the user illustrating group candidates to be adjusted in depth. FIG. 15 illustrates an example of UI display. FIG. 15 illustrates a plurality of object areas detected in FIG. 13 including imaged object area candidates 1501 to 1503. The imaged object area candidate 1501 includes the object areas 1301, 1302, and 1303. The imaged object area candidate 1502 includes the object areas 1301 and 1304. The imaged object area candidate 1503 includes the object areas 1301, 1302, 1303, and 1304. As illustrated in FIG. 15, in a case where it is difficult to automatically determine the selection of the second group, a plurality of object area candidates to be included in the depth of field may be presented. Then, the user may select it using a UI such as display panel selection (including selection on a touch panel/selection on an operation device such as a mouse operation), dial button selection, or cross key button selection. In addition to the above UI, recent cameras and display devices may include a device for detecting the user's line of sight, so the second group may be selected according to the user's line of sight information.

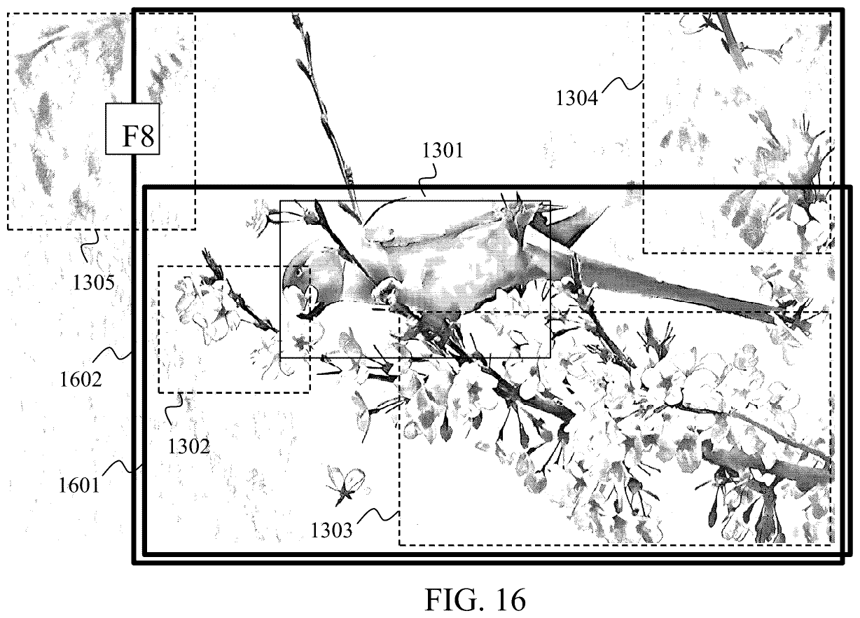

A UI display for supporting the user for depth adjustment other than the above will be described. FIG. 16 illustrates object area candidates 1601 and 1602 including a plurality of object areas detected in FIG. 13 including a UI display of the aperture value. The object area candidate 1601 is a region selected so as to be included in the depth of field in the camera 100, while the object area 1301 is selected as the first group and the object areas 1302 and 1303 are selected as the second group, and the aperture value, which is an imaging condition, is calculated to be F4. The object area candidate 1602 is an area (third group) to be included in the depth of field in a case where the aperture value as an imaging condition is changed to F8.

In addition to the object area automatically selected in the camera 100, if the aperture value for including a wider range of objects in the depth of field is displayed together with the target object area, convenient information can be provided in a case where the user intends to change the object area selected by the camera 100. Therefore, user convenience can be improved by UI-displaying the object area candidate 1602 (third group) and the aperture value (“F8” in FIG. 16) for including the object area candidate 1602 in the depth of field together in addition to the object area candidate 1601.

### Flowchart for Grouping and Depth Adjustment

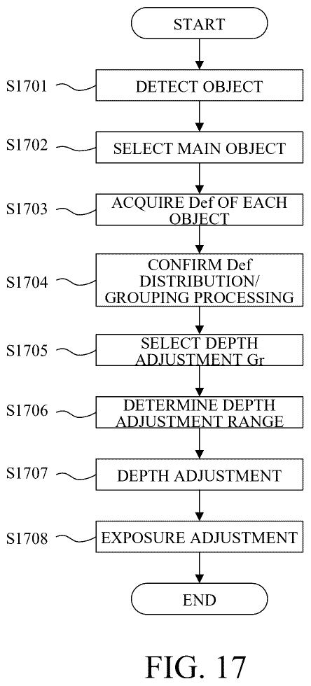

FIG. 17 is a flowchart illustrating an example of depth adjustment processing (image processing method) according to this embodiment.

In step S1701, the detector 213 detects an object in the image using image information from the image sensor 104 acquired via the control unit 201.

In step S1702, the target-area determining unit 214 determines the main object based on the object information detected by the detector 213.

In step S1703, the distance information calculator 206 calculates defocus information, which is information on a distance to each object (main object+secondary object) detected by the detector 213. At this time, a time change amount in the defocus information for each object is also calculated.

In step S1704, the target-area determining unit 214 confirms the distribution of the defocus information calculated by the distance information calculator 206, and performs grouping processing to divide the secondary objects into a plurality of groups using a proper grouping unit according to the purpose. Here, the grouping unit includes a method of calculating and evaluating a depth difference for each depth position after sorting the depth positions in value order as described above, a classifying method by the depth difference from the main object, a classifying method using training data in which a histogram of depth positions has been trained in advance, etc.

In step S1705, the target-area determining unit 214 selects the main object (which may be singular or plural) as a first group, and selects as a second group a group of sub-objects closest to the depth position of the main object from the groupings made in step S1704. At this time, as described above with reference to FIG. 14B, if the selection is difficult in the second group, a plurality of candidate groups of objects to be imaged may be displayed on the display unit 105 as illustrated in FIG. 15. In addition, the third group described with reference to FIG. 16 may be displayed on the display unit 105 together with an aperture value to be set for including in the depth of field.

In step S1706, the target-area determining unit 214 calculates a depth range (maximum and minimum values of depth position) of the object in the image area in a case where the first and second groups are viewed as a single group, using the defocus map information on the object included in the image area. Here, the image area refers to an image area that includes an image area (first area) corresponding to the first group and an image area (second area) corresponding to the second group. In this embodiment, while the first group and the second group are grouped into a single group, a difference between the maximum and minimum values of the depth position is defined as a depth difference, and an intermediate position between the maximum and minimum values of the depth position is defined as a depth position.

In step S1707, the depth-priority control unit 215 acquires a depth position and a depth difference, drives the focus lens 121 based on a control value calculated using the depth position, and drives the aperture stop 122 based on the aperture value calculated using the depth difference.

In step S1708, the exposure calculator 205 calculates a shutter speed and ISO speed using the aperture value calculated in step S1707. At this time, a time change amount in the defocus information at the depth position of the object group to be depth-adjusted is calculated from a time change amount in the defocus information on the objects in the first group and the second group calculated in step S1703. Exposure control may be performed to increase the shutter speed (to reduce the exposure time) as the time change amount is larger, or set the ISO speed higher with priority over the shutter speed. In a case where depth adjustment is performed so that a plurality of objects are included in the depth of field, the aperture value is always smaller than that when only the main object is imaged, so it is necessary to increase the exposure as exposure control. In a case where the time change amount in the defocus information at the depth position is large, decreasing the shutter speed (increasing the exposure time) increases the influence of object blur, so exposure control may be performed as described above so that the shutter speed is not as low as possible. In a case where the time change amount in the defocus information on at least one of the main object and the sub-object is larger than a predetermined amount and it is determined that it is difficult to perform depth adjustment imaging while suppressing object blur, exposure control may be performed to set the aperture value small. This is because, in a case where a user wishes to perform imaging while both the main object and secondary object are included in the depth of field but an imaging condition illustrates that the object blur is significant, the user will prefer an imaging condition that suppresses the object blur.

As described above, this embodiment groups the detected main object and secondary objects using distance information in depth-priority control, and can perform depth adjustment imaging at the best focus position and depth range that reflects the user's intention.

This embodiment uses a method in which the secondary objects are divided into a plurality of groups and then the second group is selected, but may select the second group in single processing based on the distance relationship between the main object and secondary objects, without dividing the secondary objects into a plurality of groups.

### Second Embodiment

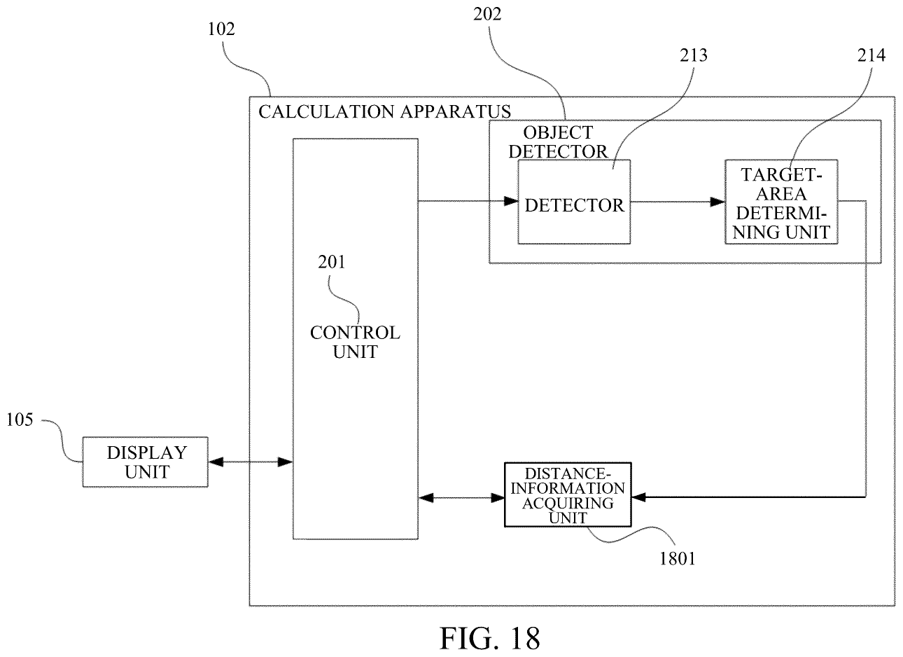

This embodiment will discuss a system configuration assuming an image processing application. FIG. 18 is a flowchart illustrating the electrical configuration of a camera according to this embodiment. In a case where the Exif information on the image data loaded by the application contains distance information, a distance-information acquiring unit 1801 acquires the distance information from the Exif information. The technology described in this embodiment has the same effect regardless of a distance-information acquiring means. Therefore, the distance-information acquiring means may calculate defocus information from the image data as in the first embodiment and acquire distance information. In an environment where a sensor configured to acquire distance data such as Lidar can be used in conjunction with an application, distance information may be acquired from the sensor. Distance information on the image information loaded by the application may be acquired from a network via a wireless/wired unit. The control unit 201 performs image processing and controls a defocus state of an image.

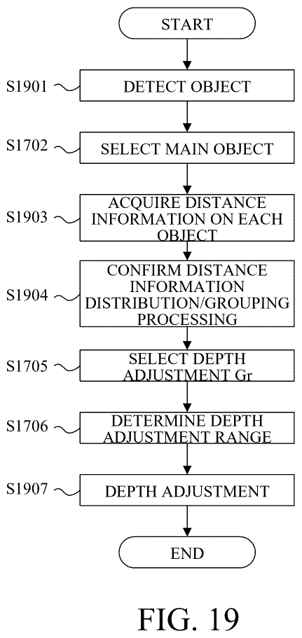

The following description in this embodiment assumes that the Exif information linked to the image information contains distance information. A description common to that in the first embodiment will be omitted. FIG. 19 is a flowchart illustrating an example of the depth adjustment processing according to this embodiment.

In step S1901, the detector 213 detects objects in an image using image information from the image sensor 104 acquired via the control unit 201.

In step S1903, the distance information calculator 206 acquires distance information on an object (main object+secondary object) detected by the detector 213 from the Exif information linked to the image information.

In step S1904, the target-area determining unit 214 confirms the distance information acquired in step S1903 and the distribution of the distance information on the objects detected by the detector 213, and performs grouping processing to divide the secondary objects into a plurality of groups.

In step S1907, the control unit 201 acquires the depth position and depth difference calculated in step S1906, performs image processing to intentionally lower the resolution for areas other than the range to be included in the depth of field, and displays the result of the image processing on the display unit 105. Here, image processing to lower the resolution includes low-pass filter processing and blur function processing that convolutes and integrates point images. If necessary, additional processing to increase resolution such as sharpness may be performed for areas that are to be included in the depth of field.

As described above, in adjusting the depth of an image using an application, this embodiment detects a main object and a secondary object from the detected objects, performs grouping processing using the distance information on each of them, and calculates the optimal depth adjustment range. Thereby, this embodiment can adjust the depth using image processing within a proper range.

### OTHER EMBODIMENTS

Embodiment(s) of the disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the disclosure has been described with reference to embodiments, it is to be understood that the disclosure is not limited to the disclosed embodiments. The scope of the following claims is to be accorded the broadest interpretation so as to encompass all such modifications and equivalent structures and functions.

Each embodiment according to the disclosure can provide an image processing apparatus configured to perform imaging at a proper focus position and depth range while suppressing degradation of image quality.

This application claims the benefit of priority to Japanese Patent Application No. 2024-189428, which was filed on Oct. 29, 2024, and which is hereby incorporated by reference herein in its entirety.

What is claimed is:

1. An image processing apparatus comprising:
one or more memories storing instructions; and
one or more processors that, upon execution of the instructions, operate to:
detect a first object and a plurality of second objects from an image,
obtain information on a distance of each of the first object and the plurality of second objects, and
determine an image area from the image including a first area including the first object and a second area including at least one second object selected from the plurality of second objects according to the information on the distance.

2. The image processing apparatus according to claim 1, wherein the information on the distance includes information based on a signal output from an image sensor.

3. The image processing apparatus according to claim 1, wherein the information on the distance includes information obtained by an optical sensor or an acoustic sensor.

4. The image processing apparatus according to claim 1, wherein the one or more processors operate to select as the second area an area including the second object corresponding to information on a distance closest to the information on the distance of the first object.

5. The image processing apparatus according to claim 1, wherein the one or more processors operate to select the second area according to a difference in the information on the distance for each of the plurality of second objects.

6. The image processing apparatus according to claim 1, wherein the one or more processors operate to select the second area according to a difference between the information on the distance of the first object and the information on the distance for each of the plurality of second objects.

7. The image processing apparatus according to claim 1, wherein the one or more processors operate to select the second area according to training data of the information on the distance.

8. The image processing apparatus according to claim 1, wherein the one or more processors operate to select a plurality of areas each including at least one of the plurality of second objects, and select the second area from the plurality of areas.

9. The image processing apparatus according to claim 8, wherein the one or more processors operate to display information on the plurality of areas.

10. The image processing apparatus according to claim 9, wherein the one or more processors operate to select as the second area an area selected from the plurality of areas according to a user operation.

11. The image processing apparatus according to claim 9, wherein the one or more processors operate to select as the second area an area selected from the plurality of areas according to line-of-sight information.

12. The image processing apparatus according to claim 9, wherein the one or more processors operate to display information on an area having a depth of field wider than that of each of the plurality of areas together with an aperture value.

13. The image processing apparatus according to claim 1, wherein the one or more processors operate to control a defocus state of the image using a defocus amount corresponding to the image area.

14. The image processing apparatus according to claim 13, wherein the one or more processors operate to control the defocus state by performing image processing.

15. The image processing apparatus according to claim 13, wherein the one or more processors operate to control the defocus state by driving an aperture stop configured to limit a light beam received by an image sensor.

16. The image processing apparatus according to claim 13, wherein the one or more processors operate to control the defocus state by driving a focus lens.

17. The image processing apparatus according to claim 13, wherein the one or more processors operate to control the defocus state so that the image area falls within a depth of field.

18. The image processing apparatus according to claim 13, wherein the one or more processors operate to control the defocus state according to a focus position and a depth of field range.

19. The image processing apparatus according to claim 18, wherein the one or more processors operate to calculate at least one of the focus position and the depth of field range using defocus map information.

20. The image processing apparatus according to claim 1, wherein the one or more processors operate to reduce an exposure time of an imaging condition of the image or set an ISO speed higher as a time change amount in the information on the distance corresponding to at least one of a plurality of objects included in the image area increases.

21. The image processing apparatus according to claim 20, wherein the one or more processors operate to reduce an aperture value in a case where the time change amount is greater than a predetermined amount.

22. An image pickup apparatus comprising:
an image processing apparatus; and
an image sensor,
wherein the image processing apparatus includes:
one or more memories storing instructions; and
one or more processors that, upon execution of the instructions, operate to:
detect a first object and a plurality of second objects from an image, obtain information on a distance of each of the first object and the plurality of second objects, and
determine an image area from the image including a first area including the first object and a second area including at least one second object selected from the plurality of second objects according to the information on the distance.

23. An image processing method comprising:
detecting a first object and a plurality of second objects from an image;
obtaining information on a distance of each of the first object and the plurality of second objects; and
determining an image area from the image including a first area including the first object and a second area including at least one second object selected from the plurality of second objects according to the information on the distance.

24. A non-transitory computer-readable storage medium storing a program that causes a computer to execute the image processing method according to claim 23.
